(19) United States
(12) Patent Application Publication
(10) Pub. No.: US 2007/0211171 A1
(43) Pub. Date: Sep. 13, 2007

(54) Console Lighting Effects

(75) Inventors: Mark A. Hunt, Derby (GB); Charles Reese, Grapevine, TX (US)

Correspondence Address: FISH & RICHARDSON, PC, P.O. BOX 1022, MINNEAPOLIS, MN, 55440-1022, US

(73) Assignee: Production Resource Group, L.L.C.

(21) Appl. No.: 11/683,906

(22) Filed: Mar. 8, 2007

Related U.S. Application Data
(60) Provisional application No. 60/781,193, filed on Mar. 9, 2006.

(51) Int. Cl. H04N 5/46

(52) U.S. Cl. 348/556

(57) ABSTRACT

New effects for controlling digital lights.

### CROSS-REFERENCE TO RELATED APPLICATION

This application claims benefit of the priority of U.S. Provisional Application Ser. No. 60/781,193 filed Mar. 9, 2006 and entitled “Console Lighting Effects”.

### BACKGROUND

Previous applications owned by Production Resource Group L.L.C have discussed in detail the use of console effects and lighting effects for stage lighting.

Stage lighting uses lights which are remotely-controllable, and have relatively high power outputs, for example higher than 100 W, but certainly higher than 200 W, and even more preferably higher than 500 W. The lights are often spotlights that are controlled and displayed preferably with a circular beam shape. That beam may be further shaped by light shaping apparatus as such as gobos.

A number of lights collectively form a lighting effect for a show or effect. Those lights can be controlled by a console. The console can be connected to the lights using a time division multiplexed control system such as DMX 512.

Lights of various types, and especially digitally controllable lights, can be controlled using the console.

### SUMMARY

The present application describes different aspects that can be carried out as effects displayed by the light. Many of these effects can be controlled from either the controlling console that controls the light, or within the light itself as an effect.

In one embodiment, the effects may be carried out in the light itself, based on controls which are sent to the light in a native format of the light's operation.

### BRIEF DESCRIPTION OF THE DRAWINGS

FIG. 1 shows the hardware structure of an embodiment;

FIG. 2 illustrates the random frame cross fading embodiment; and

FIG. 3 illustrates the blob shutter.

### DETAILED DESCRIPTION

The general structure and techniques, and more specific embodiments which can be used to effect different ways of carrying out the more general goals, are described herein.

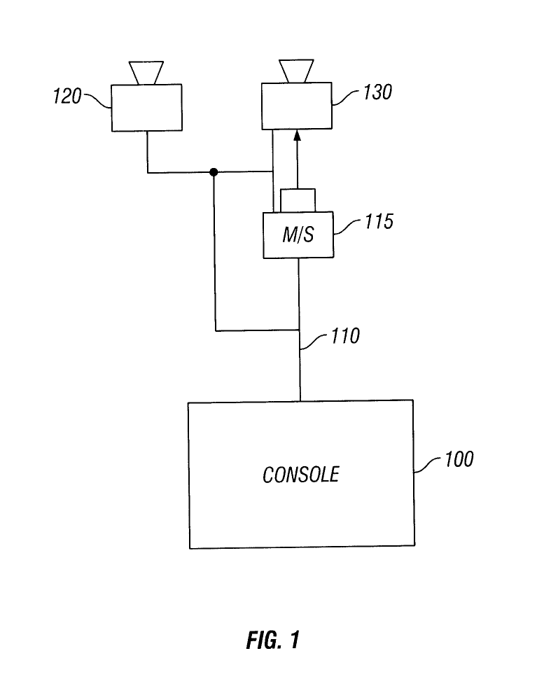

FIG. 1 illustrates an embodiment in which a controlling console 100 is connected over a connection channel 110 to a media server 115 that stores a selection of media that can be displayed by the light. The media can be videos, images or other. A connection is made to a number of lights shown as 120 and 130. The lights may be pan and tilt controllable. This thus allows controlling the beam from any light to virtually any different direction by controlling its pan and tilt direction.

The console allows controlling of a large number of lights. Encoders on the console may be individually mapped to lights, or alternatively, any light can be selected and controlled at any given time.

An embodiment describes a random playback mode of the light. The random playback mode may be used in combination with a video from the media server. Random playback mode may produce a special effect from a video, by playing back only specified parts of that video. For example, when the light is projecting a video sequence, it may play a sequence of individual frames as part of that video sequence. In the random playback mode, a section of the video sequence is selected.

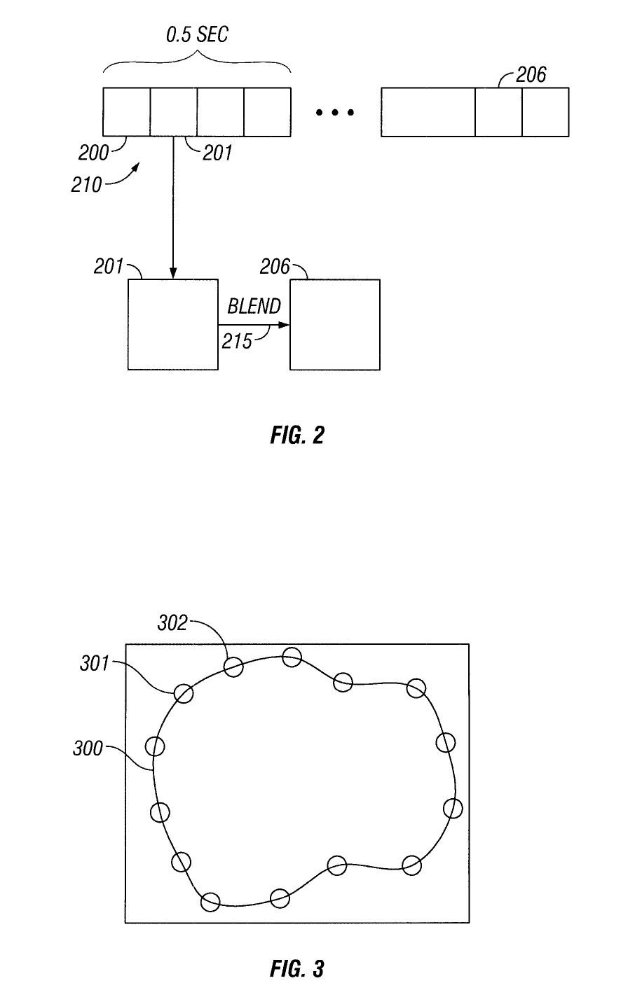

For example, FIG. 2 illustrates the video sequence, with many frames such as 200, 201 etc. within the video sequence. A section of video sequence of a specified length, for example one half second, is selected. That specified section is referred to as 210. Within the sequence 210, a random frame is selected. For instance, 201 may be selected as the random frame within the sequence. The frame 201 is then displayed for the entire half second portion.

At the end of the half second portion, a blending operation shown as 215 may be carried out, where the first random frame is blended with the next random frame 206 from the next ½ second sequence of the video. The blending can be for example a repetitive type cross fade, for example adding portions of the frame 206 to the overall projected sequence from 201, while successively subtracting portions of the frame 201. Other forms of blending are also possible, for example the blending could go through black, through white, through an average color for the frame, or others. The blending can occur for the same amount of time that the frame is displayed, or for some other amount of time. For example, a frame may be displayed for a half second, and then blended for the next half second. A suggested speed for the blending is about one second per section, with a half second displaying the random frame, and another half second blending between the first random frame and the next random frame.

Other speeds are also possible. Speeds which move the frames faster than approximately a half second will look noisy and disconcerting. However, if the speed is maintained slow enough, a video is displayed that has at least some relationship to the video from which it is derived.

Another effect relates to aspect ratio control. Sometimes, display of media such as videos by a digital light has aspect ratio information encoded into the aspect ratio. Sometimes the aspect ratio is inherent to the file. Other times, the aspect ratio of the media is encoded in the media itself, as a header of the files. Other times, the number of pixels of the aspect ratio can be determined. For example, if the media is 1024×768 pixels, then its aspect ratio is known as 1024/768=4:3. When displaying media over a stage light of this type, it sometimes may be desirable to adjust the aspect ratio. For example, stage lights of this type may spend most of the time projecting a spotlight which is a round shape. Hence, a digital light may use a spatial light modulator that is as close to round as possible, e.g., square. In that case, the resulting light may display a 1:1 aspect ratio.

Other times, a light may be used which essentially has a native aspect ratio, for example 1.6:1 or some other number. In that latter case, it may be desired to adjust the aspect ratio of the media relative to the display element.

According to this embodiment, the pixels may be altered so that the pixels become rectangular rather than square. In this embodiment, the aspect ratio is altered by changing the aspect ratio of each pixel individually. For example, to change a 1.6:1 video to a 1:1 display, each pixel is modified so that the pixel is the inverse of 1.6:1. Other techniques may alternatively be used to change the aspect ratio.

The selectable aspect ratio is controllable over a range, e.g., using any of 255 different values. Therefore, the aspect ratio can be controlled continuously over those 255 different values. In operation, one can dial through the different values until the result, e.g., the picture or video, looks right.

The aspect ratio control can also be used to change the aspect ratio in any conventional way. Different aspect ratios can be selected, and one important feature is that the aspect ratios are changeable over a continuous range of, for example, 255 different possibilities.

Another embodiment describes a blob shutter mode. Controlling digital lights, such as lights that are based on DMD or LCD or other spatial light modulators, enables shaping the outer shape of the light which is projected. These digital lights can also display any kind of content within that shaped outer perimeter. A digital framing shutter can be effected in this way.

An embodiment describes a wholly new kind of shutter, called a blob shutter. The blob shutter is like a framing shutter, but uses any curve as the outer perimeter. For example, the outer shape of the projection, within which video is being displayed, may preferably be any non-regular and/or nonsymmetrical geometric shape. The shaping, and the video projection, may both be carried out by the spatial light modulator.

An embodiment forms the shutter by using a processor to fit a curve to plural points. The embodiment operates by using the processor to determine points that define a perimeter of the shutter, where the shutter is formed by an amorphous, or “blob” type shape. These points may be, for example, randomly determined based on an image that is being shuttered by the shutter. Random points within the image may be selected. A weighting technique may be used to attempt to force the selected points to be more likely to be near the outer edges of the image. In another embodiment, the user may define preferred areas of the image, within which the framing shutter is used.

Alternatively, the points to define the shutter can be selected manually, e.g. using a graphical user interface.

A curve is then fit to the points, using curve fitting software. The curve forms a smooth curve between the points. The curve, shown as 300 in FIG. 3, connects each of the points such as 301, 302.

The curve is then used as a shutter: with everything outside the curve is controlled to be black, while everything inside the curve is controlled to project media of the specified type.

The curve can also be animated, where the points can be changed in either a cyclical or random fashion, in order to animate the shutter that forms the perimeter of the projected image.

Another application is use of the control line 110 that extends from the console to the media server and/or lights 120,130 for new functions not previously considered. The control line has been used to control light functions, to change color, move the output position, etc. In this embodiment, the control line is also used for control of housekeeping of the hardware—a purpose that is completely different than any previous purpose of the control line.

In an embodiment, a restart command can be sent from the console 100 to either the media server 115 or any individual light 120. This is done over the line that is usually used for control of lighting effects. For example, if the media server is malfunctioning, or if the lights themselves are malfunctioning, then the housekeeping function can be used.

In embodiments, the housekeeping function can be used to cause restart, reset or shutdown of any of the computing systems that are controlled by the console.

For example, restart may be carried out by sending a specified restart command to any of the controlled systems. This may be a dedicated command that is sent over the existing line, which can be an Ethernet line, arcnet control, or DMX control. As an alternative, the restart command may require that a specified set of commands he sent one after another. During control of the show, for example, it could be catastrophic to have an accidental restart. Accordingly, the restart command may require a number of serial commands to be entered.

Another remotely controllable function is rescan of the files. For example, it may be possible to add new files to be displayed by a digital light or media server. New media files, for example, can be added to the storage within the media server. The console can command the media server 115 to rescan all its files and produce an updated list by an appropriate command over the line 110.

The remote control can alternatively be used to shut down or quit the computer or application.

The DMX channels have a limited number of possible values. Also, as discussed above, and an improper restart or shutdown of the computer at the wrong time could be disastrous. Accordingly, in this embodiment, the control of the media server or other computers can only be effected by a special sequence of commands. For example, a sequence of commands on the DMX value in one embodiment requires that the DMX channel go to a certain value, such as 182, and remain there for 30 seconds, then go immediately to zero, and remain there for a specified time. The controller in the media server and/or lights is programmed to watch for this specified sequence. The controller takes an action based on the specified sequence. Any sequence that is difficult to do by accident can be used for this purpose. The sequence is preferably multiple different values in a sequence, to minimize the possibility of accidental actuation.

Another embodiment is usable when SDI outputs are used for the control. For example, the red, green and blue gains of the SDI output may be adjusted by the controller. SDI also has a gamma control for the video card. For example, depending on the characteristics of the light such as 130, one might want to set one or more of the color channels to have a higher gain. Depending on the look of the light, for example, one might want to emphasize the gain of the red channel. The black level can also be set to match to the light.

Another aspect describes dynamic effects: that is effects which are dynamic in time and change as a function of time. The controls can be set which causes a continual change of the image being displayed by the digital light. The displayed image may include the media which is being displayed or may be gobo value that defines the perimeter of the media.

Example effects include shake, wobble, wave, which may be for example similar to the effect of a flag-waving, flickering, like a candle, and static, as in static noise. Any of these effects may change the outer perimeter shape of the projected light according to the processed effect. A basic shape, e.g., circle or triangle, may be modified using the wave or wobble etc, so that the outer perimeter defining the gobo itself includes these effects.

The dynamic effects can include movement of the media in the x and y directions based on controls for the speed and the size of the shake. A wobble effect adds a z axis rotation to the shake effect. Wave effect may also add a waving flag type, and may be based on a random kernel or seed, as necessary.

An object cross fade automatically allows fading between different objects, e.g., three-dimensional objects, on a single control layer. When the objects are formed of different objects, a fade between those objects can be carried out by fading out the outgoing object while simultaneously fading in a different incoming object based on a time control. When switching is carried out with object cross fading enabled, it automatically fades out and fades in on the same layer. This may be advantageous as compared with other systems which fade out one layer while fading in a second layer. In contrast, this system may be simpler to program, and also requires less maintenance of variables.

The general structure and techniques, and more specific embodiments which can be used to effect different ways of carrying out the more general goals are described herein.

Although only a few embodiments have been disclosed in detail above, other embodiments are possible and the inventor(s) intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, different effects may also be possible.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation.

The computer which operates the console and/or the lights may be a Pentium class computer, running Windows XP or Linux, or may be a Macintosh computer. The programs may be written in C, or Java, or any other programming language. The programs may be resident on a storage medium, e.g., magnetic or optical, e.g. the computer hard drive, a removable disk or other removable medium. The programs may also be run over a network, for example, with a server or other machine sending signals to the local machine, which allows the local machine to carry out the operations described herein.

1. A method, comprising:
receiving video information; and
displaying said video information at an aspect ratio different than its native aspect ratio by changing an aspect ratio of each of a plurality of individual pixels making up said video information.

2. A method as in claim 1, further comprising
determining an aspect ratio of the video information,
determining an aspect ratio information of a display part that is displaying the video information, and wherein said changing being based on a difference between the aspect ratio of the video information and the aspect ratio of display part.

3. A method as in claim 2, wherein the determining an aspect ratio of the video information comprises finding the aspect ratio from aspect ratio information encoded within the media.

4. A method as in claim 1, wherein the determining the aspect ratio comprises finding an aspect ratio based on contents of the media.

5. A method as in claim 1, further comprising selecting an aspect ratio at which the video information will be displayed.

6. A method as in claim 1, wherein said selecting comprises allowing selection of any of a plurality of preset aspect ratios.

7. A method as in claim 6, wherein said selecting comprises using a dial, to select one of plural different preset aspect ratios.

8. A method, comprising:
receiving video information to be displayed;
forming a plurality of different preset aspect ratios for said video information; and
using a manually actuable control to select one of said aspect ratios, and to display said video information in each of said ratios according to said switching.

9. A method as in claim 8, wherein said manually actuable control is a dial that can be selected via turning the dial to a specified setting, each of a plurality of areas associated with the dial representing a different aspect ratio, and said using a dial comprising switching between the multiple different aspect ratios.

10. A method as in claim 8, wherein said displaying comprises changing an aspect ratio of the video by changing a shape of each of a plurality of pixels.

11. An apparatus, comprising:
a video part that receives video information; and
a display processor, operating to display said video information at an aspect ratio different than its native aspect ratio by changing an aspect ratio of each of a plurality of individual pixels making up said video information.

12. An apparatus as in claim 11, wherein said display processor determines an aspect ratio of the video information, determines an aspect ratio information of a display part that is displaying the video information, and changes the aspect ratio of the video information based on a difference between the aspect ratio of the video information and the aspect ratio of the display part.

13. An apparatus as in claim 12, wherein the determining an aspect ratio of the video information comprises finding the aspect ratio from aspect ratio information encoded within the media.

14. An apparatus as in claim 12, wherein the display processor finds an aspect ratio based on contents of the media.

15. An apparatus as in claim 12, further comprising a display control that allows selection of any of a plurality of preset aspect ratios.

16. An apparatus as in claim 15, wherein said display control includes a dial which is turned to select one of plural different preset aspect ratios.

17. An apparatus, comprising:
A video processor forming a plurality of different preset aspect ratios for video information to be displayed; and
a manually actuable control which allows selection of one of said aspect rations, and allows displaying of said video information in each of said ratios according to said switching.

18. An apparatus as in claim 17, wherein said manually actuable control is a dial that can be selected via turning the dial to a specified setting, each of a plurality of areas associated with the dial representing a different aspect ratio, and moving said dial causes switching between the multiple different aspect ratios.

19. An apparatus as in claim 17, wherein said video processor changes an aspect ratio of the video by changing a shape of each of a plurality of pixels.

20. A method, comprising:
obtaining information indicative of a video sequence;
selecting only certain separated frames within the video sequence with time periods between the separated frames; and
displaying each of the separated frames for a specified display time, where the specified display time is related to an amount of time between the separated frames.

21. A method as in claim 20, wherein said displaying comprises cross-fading between two of the separated frames.

22. A method as in claim 20, wherein said displaying comprises displaying the separated frame for a first part of the specified display time, and transitioning to another frame for a second part of the specified display time.

23. A method as in claim 22, wherein said transitioning to another frame comprises cross-fading to another frame.

24. A method as in claim 22, wherein said transitioning to another frame comprises transitioning through a specified color.

25. A method as in claim 22, wherein said transitioning to another frame comprises transitioning through an average color of a frame.

26. A method as in claim 22, wherein said first part of the display time and the second part of the display time are substantially the same amount of time.

27. A method as in claim 20, wherein said selecting only separated frames within the video sequence comprises defining a time period between frames, and choosing a single frame within said time period.

28. A method as in claim 27, wherein said selecting the frame comprises selecting a random frame.

29. A method as in claim 27, wherein said selecting the frame comprises choosing a frame within a first portion of the time period, and using a second portion of the time period for transitioning to another frame.

30. A method as in claim 19, further comprising remotely controlling an operation of said displaying, from a console that controls multiple lighting devices, each of which can carry out said obtaining, selecting and displaying.

31. A system, comprising:
a video displaying portion, receiving remote control commands, and receiving at least one media file, representing an item of media to be displayed by said video displaying portion; and
a video processor, processing said media file, to obtain information indicative of a video sequence within said item of media, select only certain separated frames within the video sequence; and displaying each of the separated frames for a specified display time, where the specified display time is related to an amount of time between the separated frames.

32. A system as in claim 31, wherein said video processor cross-fades between two of the separated frames to display information contained therein.

33. A system as in claim 31 wherein said video processor displays the separated frame for a first part of the specified display time, and transitioning to another frame for a second part of the specified display time.

34. A system as in claim 33, wherein said video processor carries out said transitioning to another frame by cross-fading to another frame.

35. A system as in claim 33 wherein said video processor carries out transitioning to another frame by transitioning through a specified color.

36. A system as in claim 31, wherein said video processor carries out transitioning to another frame by transitioning through an average color of a frame.

37. A system as in claim 31, wherein said first part of the display time and the second part of the display time are substantially the same amount of time.

38. A system as in claim 31, wherein said video processor selects only separated frames within the video sequence by defining a time period between frames, and selecting a single frame within said time period.

39. A system as in claim 31, wherein said video processor selects a random frame.

40. A system as in claim 31, wherein said video processor selects frames by selecting a frame within a first portion of the time period, and using a second portion of the time period for transitioning to another frame.

41. A system as in claim 31, further comprising a console that controls multiple lighting devices, each of which has video processor, processing said media file, to obtain information indicative of a video sequence within said item of media, select only certain separated frames within the video sequence; and displaying each of the separated frames for a specified display time, where the specified display time is related to an amount of time between the separated frames; and
a control port, associated with said video processor and said video displaying part, which receives commands for remotely controlling an operation of said video display portion.

42. An apparatus comprising:
a light that projects media that has an outer shape that is shaped according to a non-regular geometric shape.

43. An apparatus as in claim 42, wherein said light includes a spatial light modulator, and a processor controlling said spatial light modulator, wherein said processor controls said spatial light modulator both to project a video, and to shape the video according to the non-regular geometric shape.

44. An apparatus as in claim 43, wherein said non-regular geometric shape is defined according to a curve.

45. An apparatus as in claim 43, wherein said non-geometric shape is nonsymmetrical.

46. An apparatus as in claim 43, wherein said spatial light modulator also controls projection of said media, and wherein said media is an image.

47. An apparatus as in claim 46, wherein said image changes over time.

48. An apparatus as in claim 46, wherein said processor also operates to determine points within said image, and use said points to define said outer shape.

49. An apparatus as in claim 48, wherein said processor operates according to a weighting function, said weighting function making it more likely that said points which are determined will be towards an outer edge of the image.

50. Apparatus as in claim 48, wherein said points are determined manually.

51. An apparatus as in claim 48, wherein said points are used by fitting a curve between said points.

52. An apparatus as in claim 51, wherein said curve is a smooth curve that is fit between the points.

53. An apparatus as in claim 51, wherein said spatial light modulator is controlled by the processor to color everything outside the curve as black, and everything inside the curve as said specified media.

54. An apparatus as in claim 51, wherein said curve is animated by said processor.

55. An apparatus comprising:
a controller that produces an output signal that controls projection of media that is one of an image or a video to have an outer shape that is shaped according to a non-regular geometric shape.

56. An apparatus as in claim 55, wherein said non-regular geometric shape is defined according to a curve.

57. An apparatus as in claim 56, wherein said non-geometric shape is nonsymmetrical.

58. An apparatus as in claim 55, wherein said output signal includes information indicative of said media, and information indicative of said shape.

59. An apparatus as in claim 55, wherein said media is an image that changes over time.

60. An apparatus as in claim 58, wherein said information indicative of said shape includes information indicative of points within said media, which points define said outer shape.

61. An apparatus as in claim 60, wherein said outer shape is a smooth curve that is fit between the points.

62. An apparatus as in claim 51, further comprising controlling said outer shape to be animated.

63. A method comprising:
projecting media that includes an image or a video, with an outer shape that is shaped according to a non-regular geometric shape.

64. A method as in claim 63, wherein said projecting comprises using a spatial light modulator to project said media, and to shape the video according to the non-regular geometric shape.

65. A method as in claim 63, further comprising defining said non-regular geometric shape according to a curve.

66. A method as in claim 63, wherein said non-geometric shape is nonsymmetrical.

67. A method as in claim 63, further comprising determining points within said media, and using said points to define said outer shape.

68. A method as in claim 67, further comprising operating according to a weighting function which makes it more likely that said points will be towards an outer edge of the image.

69. Apparatus as in claim 63, further comprising determining said points manually.

70. A method as in claim 63, further comprising fitting a curve between said points.

71. A method as in claim 64, wherein said spatial light modulator is controlled to color everything outside the shape as black, and everything inside the shape as said specified media.

72. A method as in claim 64, further comprising animating said shape.

73. An apparatus, comprising:
a light that projects media which includes at least one of images or video, the outer perimeter of said media being shuttered according to an outer shape that has a nonregular shape, and which is animated.

74. An apparatus as in claim 73, wherein said light operates using a spatial light modulator.

75. A method, comprising:
producing a control signal for a light to project media, which is one of video or an image, which has its outer perimeter shaped and shuttered according to a nonregular animated shape.

76. A method, comprising,:
sending a control signal from a controlling console to a light to control functions of the light; and
sending a reset signal from said controlling console to said light, over a same channel that controls the controlling functions.

77. A method as in claim 76, wherein said sending a reset signal comprises sending a reset signal that is formed by a combination of sequences separated by times.

78. A method as in claim 76, wherein said reset signal is sent via DMX.

79. A method as in claim 76, wherein said reset signal is a signal which causes the computer to reset.

80. A method as in claim 76, wherein said reset signal is a signal that causes the computer to restart.

81. A method as in claim 76, wherein said reset signal is a signal that causes the computer to shut down.

82. A method, comprising:
sending a control signal over a control line that extends from the controlling console to a light that controls functions of the light including movement of the light,
changing color of the light, at a first time; and
at a second time, sending a housekeeping signal from the controlling console to the light, where the housekeeping signal causes the light to carry out a function unrelated to immediate operation.

83. A method as in claim 82, wherein said control line is DMX.

84. A method as in claim 82, wherein said housekeeping signal is formed by a sequence of commands.

85. A method as in claim 84, wherein said housekeeping signal is formed by a first command to a first value, remaining at that first value for a time, and then going to another value.

86. A method as in claim 85, wherein said housekeeping signal is a reset signal.

87. A method as in claim 85, wherein said housekeeping signal is a shutdown signal.

88. A method as in claim 85, wherein said housekeeping signal is a signal that causes the light to rescan all of its media files and create new information indicative of the media files.

89. An apparatus, comprising:
a port for receiving information from a control line that extends from a controlling console, said information including control information that controls functions of the light, including movement of the light,
a color changer, that changes color of the light, at a first time responsive to said information; and
a housekeeping device, associated with the light, which is controlled by other information on said control line, and carries out a function unrelated to immediate operation.

90. An apparatus as in claim 89, wherein said control line includes DMX information.

91. An apparatus as in claim 89, wherein said housekeeping signal is formed by a sequence of commands.

92. An apparatus as in claim 91, wherein said housekeeping device monitors for a first command to a first value, remaining at that first value for a time, and then going to another value.

93. An apparatus as in claim 92, wherein said housekeeping signal is a reset signal.

94. An apparatus as in claim 92, wherein said housekeeping signal is a shutdown signal.

95. An apparatus as in claim 92, further comprising a media server storing media files, wherein said housekeeping signal is a signal that causes the light to rescan all of its media files and create new information indicative of the media files in the media server.

96. A method, comprising:
displaying a media file;
continually changing a parameter of the media filed during the time that it is being displayed.

97. A method as in claim 96, wherein said continually changing a parameter comprises can changing a shape of an outer perimeter of the media continually.

98. A method as in claim 96, wherein said continually changing comprises using a random effect on the outer perimeter.

99. A method as in claim 96, wherein said effect on the outer perimeter comprises an effect similar to that of a flag waving.

100. A method as in claim 96, wherein said effect comprises an effect that includes a z-axis rotation.
